(19) United States
(12) Patent Application Publication
(10) Pub. No.: US 2017/0071698 A1
(43) Pub. Date: Mar. 16, 2017

(54) DENTAL OBTURATOR MADE OF GUTTA PERCHA COMPONENTS

(71) Applicant: Kerr Corporation, Orange, CA (US)

(72) Inventors: Emanuele Maretto, Orange, CA (US); David Tak Kei Lui, Chino Hills, CA (US); Marie Lauro, Newport Beach, CA (US); Gopikrishnan Soundararajan, Santa Clara, CA (US)

(21) Appl. No.: 15/259,194

(22) Filed: Sep. 8, 2016

Related U.S. Application Data
(60) Provisional application No. 62/216,846, filed on Sep. 10, 2015.

(51) Int. Cl. A61C 5/04; A61C 5/02

(52) U.S. Cl. CPC A61C 5/045; A61C 5/02

(57) ABSTRACT

An endodontic obturator for obturating a root canal includes a wire made of a conductive material, a carrier, and a sheath. The carrier is configured to releasably couple to the wire and is made of a first thermoset material. The sheath is configured to slidably receive the carrier and is made of a second thermoset material. The melting temperature of the second thermoset material is lower than the melting temperature of the first thermoset material. A method of obturating a root canal includes positioning the endodontic obturator in the root canal, ensuring the endodontic obturator is in a proper position by locating an apex of the root canal using the wire, sealing an apex of the root canal with the sheath, and removing the wire from the obturator.

### CROSS REFERENCE TO RELATED APPLICATIONS

This application claims the benefit of U.S. Provisional Patent Application Ser. No. 62/216,846 filed Sep. 10, 2015, the disclosure of which is expressly incorporated by reference herein in its entirety.

### FIELD OF THE INVENTION

This invention relates to an apparatus and method for obturating a root canal.

### BACKGROUND OF THE INVENTION

Dental root canal treatment generally involves three stages: shaping, cleaning, and obturation (generally involving filling and sealing). Ultimately, the goal of a root canal treatment is to eliminate the infection inside the dental root system and to tightly seal or obturate the small opening at the end of the root canal (i.e., the apex). Failure to completely seal the apex or the root canal leads to micro-leakage, which will allow future bacteria colonization inside the root canal system, re-infection, and possible loss of the tooth. Micro-leakage is the most common cause of tooth failure.

Traditional methods of obturating an extirpated or stripped root canal commonly involve packing the root canal with a thermoplastic material, such as gutta percha (e.g., trans 1-4 polyisoprene or polysulfone), so that the root canal space is filled with the thermoplastic material. The filling material is generally shaped into a slender cone having a small taper angle (e.g., 5 to 10 degrees). Preferably, the space is filled with the thermoplastic material forming a seal that prevents leakage between the root canal and the surrounding tissue. To ensure that the thermoplastic material is positioned adjacent to the apex for a proper seal, clinicians attempt to locate the apex. Traditional methods of locating the apex, such as using x-rays and radiovisiographs, do not always provide the clinician with an accurate view of whether the thermoplastic material has reached filled the apex of the root canal.

A satisfactory seal can be formed by softening the thermoplastic material by heating it prior to inserting it into the root canal. Conventionally, the gutta percha is applied to a carrier, often made of plastic, prior to insertion into the root canal in order to facilitate insertion. A carrier may be pre-coated with the gutta percha. However, carriers pre-coated with gutta percha are expensive to purchase, and a less expensive means is desired for applying gutta percha to a carrier. The carrier is often designed to permanently stay inside the root canal system as part of the final seal. When root canal retreatment is needed, the presence of the carrier may present difficulties when attempting to regain access to the apex area of the root canal. For instance, a rotating file often has difficulty penetrating the carrier, and instead simply slides to one side of the carrier.

By providing a carrier formed of a thermoset material (e.g., gutta percha), retreatment of a root canal may be simplified. Ideally, the improved carrier composition would have a desirable stiffness while generally being capable of maintaining its shape after the application of heat (e.g., during retreatment of a tooth). Additionally, providing an improved method of locating the apex of the root canal during obturation will improve the efficacy of the seal.

### SUMMARY OF THE INVENTION

The present invention provides an endodontic obturator for obturating a root canal including a wire made of a conductive material, a carrier configured to releasably couple to the wire, the carrier being made of a first thermoset material, and a sheath configured to receive the carrier, the sheath being made of a second thermoset material. A melting temperature of the second thermoset material is lower than a melting temperature of the first thermoset material.

The present invention provides a method of obturating a root canal using an endodontic obturator comprising a wire, a carrier, and a sheath. The method includes positioning the endodontic obturator in the root canal, ensuring the endodontic obturator is in a proper position by locating an apex of the root canal using the wire, sealing an apex of the root canal with the sheath, and removing the wire from the obturator.

The present invention further provides a method of making an endodontic obturator including molding a carrier made of a first thermoset material around a conductive wire, molding a sheath made of a second thermoset material, and coupling the carrier and the sheath.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an endodontic obturator according to an embodiment.

FIG. 2A is a cross-sectional view of the endodontic obturator of FIG. 1 positioned in a root canal.

FIGS. 2B and 2C are cross-sectional views of the endodontic obturator of FIG. 1 during removal of the wire.

FIG. 2D is a cross-sectional view of the endodontic obturator of FIG. 1 after the wire has been removed.

FIG. 3 is a cross-sectional view of a tooth after the obturation of a root canal with an endodontic obturator according to an embodiment.

### DETAILED DESCRIPTION

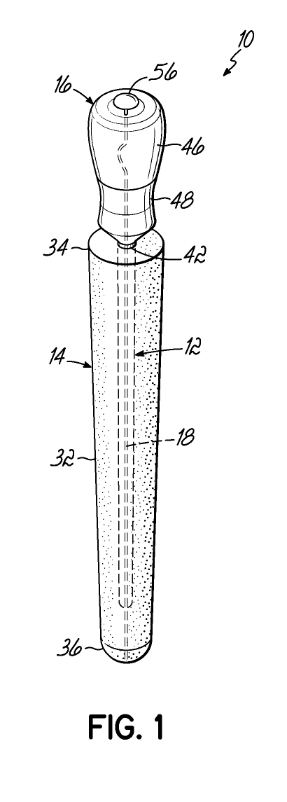

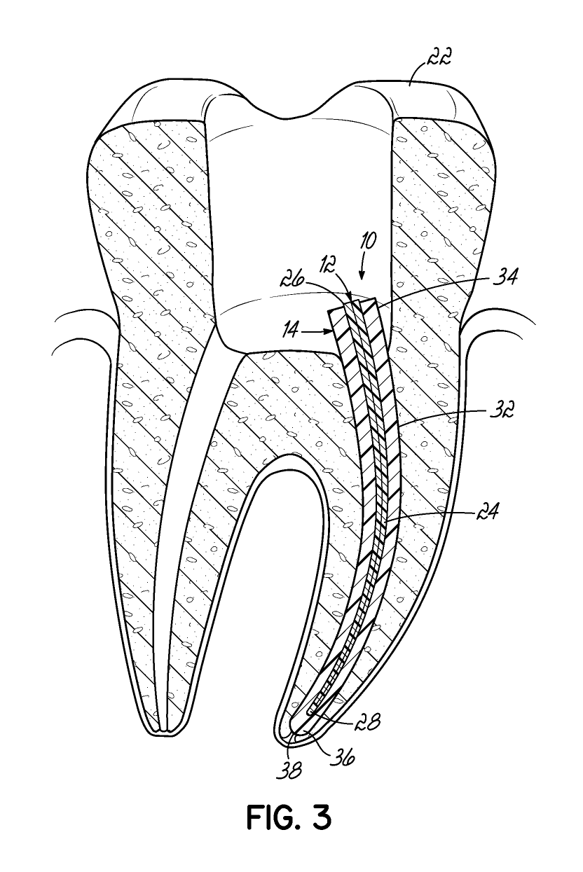

Referring first to FIG. 1, in an embodiment of the invention, an endodontic obturator 10 includes a carrier 12 and a sheath 14. The carrier 12 and the sheath 14 are coupled, for example, via an interference fit. The endodontic obturator 10 further includes a handle 16 coupled to a wire 18, which extends through carrier 12 and sheath 14. The endodontic obturator 10 is configured to seal a stripped root canal 20 during a root canal treatment of a tooth 22 (as shown in FIG. 3). The wire 18, in an embodiment, is used to properly position the endodontic obturator 10 (discussed further below).

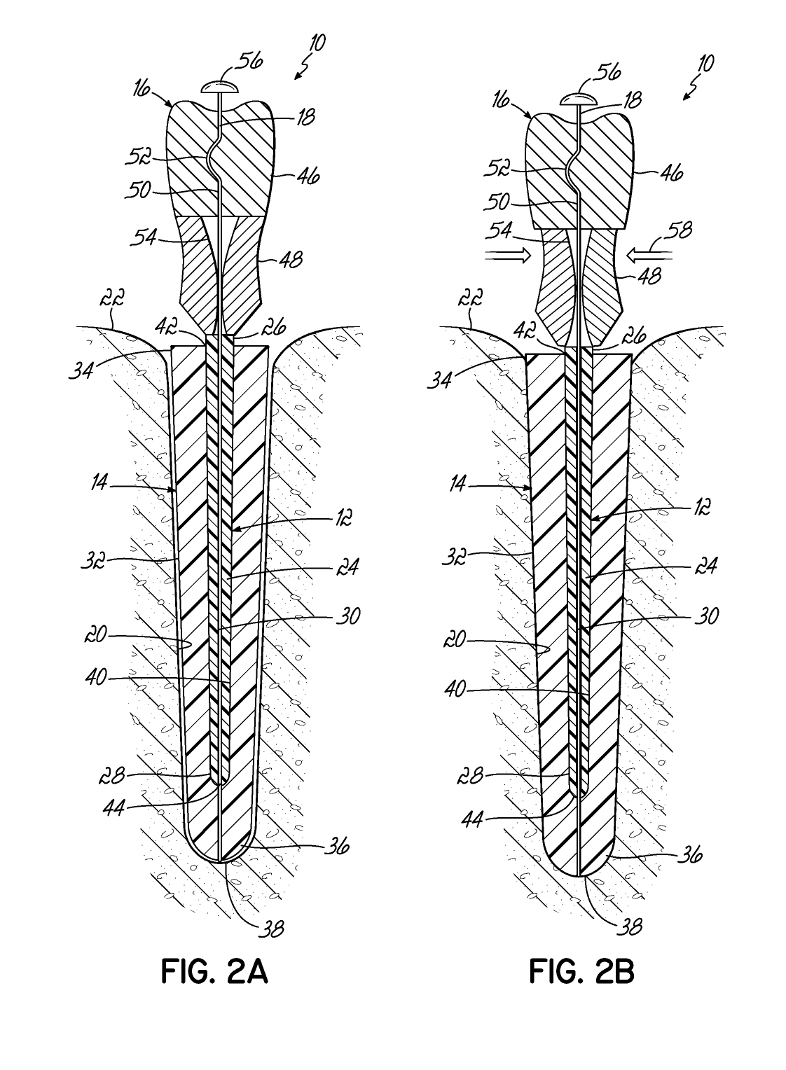

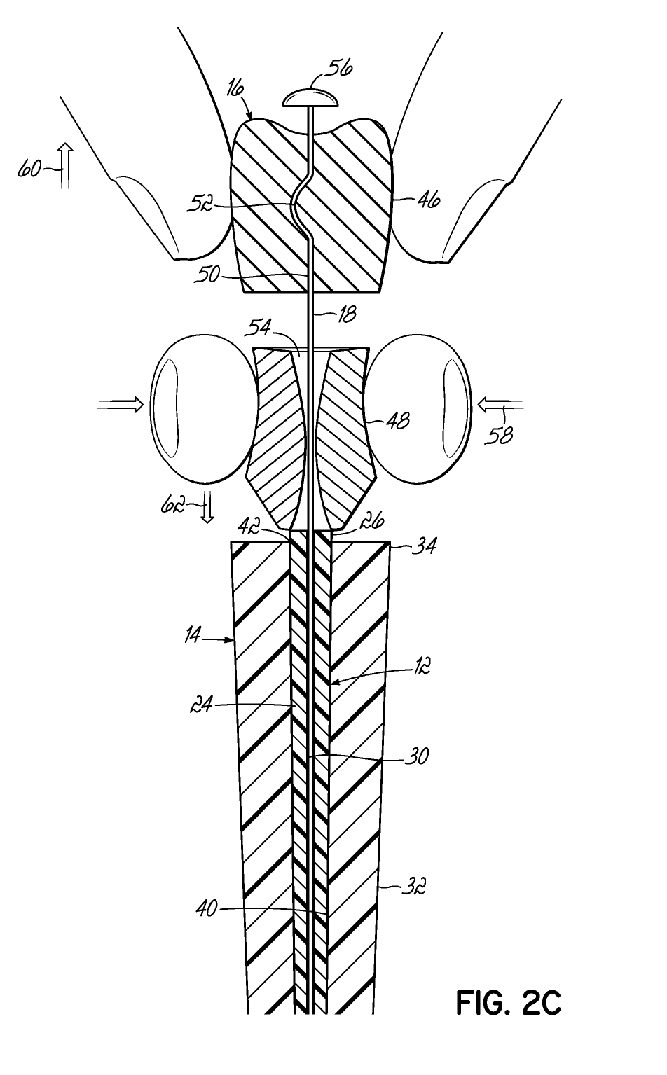

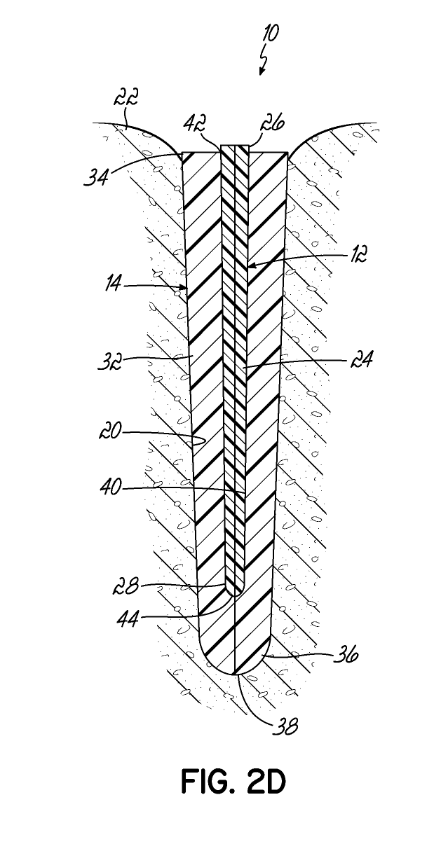

With reference now to FIG. 2A, the carrier 12 has an elongate, tapered body 24 having a first end 26 (proximal) and a second end 28 (distal). The carrier 12 is configured to releasably couple to the wire 18. When the wire 18 is releasably coupled to the carrier 12, the wire 18 extends within a cavity 30. In an embodiment, the carrier 12 is formed of gutta percha having a high melting temperature. The gutta percha may be formed (e.g., molded) into the tapered body 24 of the carrier 12 that, when cooled, may substantially hold its shape during the expected lifetime of the obturation. The gutta percha may have relatively poor tear properties compared to conventional plastic carriers, thus making it easy to penetrate the carrier 12 with a rotating file (e.g., during root canal retreatment). One of ordinary skill will recognize that other natural or synthetic heat flowable polymeric materials that are bio-inert or bio-compatible when disposed in dental root canals may be used to form the carrier 12.

With further reference to FIG. 2A, the sheath 14 is defined by an elongate, tapered body 32 having a first end 34 (proximal) and a second end 36 (distal). The sheath 14 is designed to be positioned in the root canal 20, and the second end 36 is configured to seal an apex 38 of the root canal 20 during treatment. The sheath 14 is configured to releasably couple to the wire 18, similar to the carrier 12. The sheath 14 includes a cavity 40. The cavity 40 is open to an aperture 42 at the first end 34 of the tapered body 32 and terminates in a tip 44. The cavity 40 is configured to surround the carrier 12. In an embodiment where the carrier 12 and the sheath 14 are coupled via an interference fit, the cavity 40 may be configured to slidably receive the carrier 12. The sheath 14 is formed of gutta percha having a low melting temperature. More particularly, the sheath 14 is formed of a gutta percha having a melting temperature that is lower than the melting temperature of the gutta percha that forms the carrier 12. In an embodiment, sheath 14 may have a melting temperature of about 80° C. to about 90° C., and carrier 12 may have a melting temperature of about 180° C. to about 220° C. In this configuration, the endodontic obturator 10 includes an inner core (e.g., the carrier 12) of a material that will remain relatively rigid and stable while an outer shell (e.g., the sheath 14) is softened for placement in and sealing of the root canal 20.

In an embodiment, the thermoset material (e.g., gutta percha) used to form the carrier 12 and the sheath 14 may include a matrix of thermoset material with heat conductive particles dispersed in the matrix (not shown). The heat conductive particles improve the thermal mechanical properties of gutta percha, for example, by increasing the heat conductivity of the gutta percha. Using the improved gutta percha material in the endodontic obturator 10 reduces the operating temperature for root canal treatment procedures. Additionally, when the sheath 14 cools, the gutta percha undergoes a slight dimensional expansion instead of the conventional shrinkage, which allows for a better seal between the endodontic obturator 10 and the root canal 20. The heat conductive particles may be of sub-micron size and are preferably bio-inert. The shape of the particles may be regular, irregular, symmetrical or non-symmetrical, having random or specific geometrical shapes (e.g., spherical, ellipsoidal, disc, etc.). The characteristic size of the particles is on the order of 1 micron or less and need not be uniform. In an embodiment, the characteristic size is 0.5 to 1 micron. In another embodiment, the characteristic size is on the order of 100 nm or less, in the nanoparticle range. The heat conductive particles may be generally or substantially the same size, or have random sizes within the prescribed size range. The particles may be made of high heat conductive metal, non-metal, organic or inorganic materials, including without limitations zinc oxide, magnesium silicate, gold, silver, titanium, diamond, etc. The type, quantity, and/or size of the heat conductive particles may be varied to alter the thermal characteristics of the gutta percha material. For example, a larger quantity of heat conductive metal particles may be added to the matrix to create a lower melting temperature. For another example, non-conductive particles may also be added with the heat conductive particles to create a higher melting temperature.

With reference again to FIG. 2A, the handle 16 includes a first handle portion 46 and a second handle portion 48. In an embodiment, the first and second handle portions 46, 48 may be dimensioned to be manipulated between the thumb and forefinger of the clinician. Alternatively, the first and second handle portions 46, 48 may be dimensioned to be manipulated by a dental tool, such as dental tweezers. The first and second handle portions 46, 48 are releasably coupled together. More specifically, the handle 16 may include one or more features that releasably couple the first and second handle portions 46, 48. In an embodiment, the handle 16 may be molded to include a frangible projection or lip (not shown) that couples the first and second handle portions 46, 48. When the clinician squeezes the second handle portion 48, the lip may disconnect from the first handle portion 46, which can then be moved away from the second handle portion 48. The handle 16 is adjacent to the carrier 12 and the sheath 14. The wire extends through both the first and second handle portions 46, 48. The first handle portion 46 includes a channel 50 configured to secure the wire 18. In an embodiment, the first handle portion 46 includes a crimp 52 that secures the wire 18 in the channel 50. The second handle portion 48 includes a channel 54 configured to slidably receive the wire 18. When the first and second handle portions 46, 48 are separated, the clinician may move the first handle portion 46 to draw the wire 18 through the second handle portion 48.

Still referring to FIG. 2A, the wire 18 extends from the first handle portion 46, through the second handle portion 48, through the cavity 30 of the carrier 12, and to the second end 36 of the sheath 14. The wire 18 may provide additional stiffness to the carrier 12 and the sheath 14. In an embodiment, the wire 18 may be conductive (e.g., made of metal) and may include a metal contact portion 56 that extends from the first handle portion 46. In this manner, the wire 18 can be used as an electrode for an apex locator device (not shown) to locate the apex 38 of a root canal 20. A wire from the apex locator device may be attached to the metal contact portion 56 at the handle 16, and the endodontic obturator 10 may act as the probe for the apex locator device. The metal may be made of, for example, stainless steel, NiTi, or copper.

A method of using the endodontic obturator 10 during a dental root canal treatment process will be described with reference to FIGS. 2A-2D. In an embodiment, the clinician inserts the endodontic obturator 10 into the stripped root canal 20. The clinician may connect the metal contact portion 56 to an apex locator device (not shown) to locate the apex 38 of the root canal 20. Using the apex locator device, the clinician may adjust the position of the endodontic obturator 10. When the endodontic obturator 10 is in the desired position in the root canal 20, heat is applied to the sheath 14 using a heating tool (e.g., a heat gun). As the gutta percha matrix of the sheath 14 softens under the applied heat, the shape of the sheath 14 adjusts to fill and seal the root canal 20. Ideally, sufficient heat reaches the second end 36 of the sheath 14 to mold the second end 36 to completely fill the apex 38 of the root canal 20, as shown in FIG. 2B. During this process, the conductive particles within the gutta percha matrix facilitate heat conduction through the sheath 14 to the second end 36. However, because of the higher melting temperature of the gutta percha used to form the carrier 12, the carrier 12 generally retains its shape and rigidity while the sheath 14 is heated. Alternatively, the endodontic obturator 10 may undergo heating before being inserted into the root canal 20. For instance, the endodontic obturator 10 may be softened in an oven.

Once the sheath 14 has sealed the apex 38 of the root canal 20, the clinician may remove the wire 18 from the endodontic obturator 10. As shown in FIGS. 2B and 2C, the clinician may grip or pinch both the first and second handle portions 46, 48 (indicated by arrows 58) to separate the first handle portion 46 from the second handle portion 48. As the clinician pulls the first handle portion 46 away from the endodontic obturator 10 (indicated by arrow 60), the wire 18 slides out of the carrier 12 and through the second handle portion 48. The clinician may apply pressure on the second handle portion 48 (indicated by arrow 62) to prevent the carrier 12 and/or the sheath 14 from moving out of the root canal 20 due to the movement of the wire 18, as shown in FIG. 2C. The removal of the wire 18 creates hydraulic pressure within the carrier 12 and causes the gutta percha to fill the void left by the wire 18. In other words, the cavity 30 of the carrier 12 is not present after the wire 18 is withdrawn, as shown in FIG. 2D. The clinician may then remove the second handle portion 48 from the endodontic obturator 10. Removing the wire 18 from the endodontic obturator 10 allows for easier retreatment as compared to a wire or electrode that remains in the root canal 20. FIG. 3 illustrates the tooth 22 with the endodontic obturator 10 sealing the apex 38 of the root canal 20 after the obturation is complete.

In an embodiment, a method of making the endodontic obturator 10 includes molding the carrier 12 around the wire 18, molding the sheath 14, and coupling the carrier 12 and sheath 14. The wire 18 is secured to the first handle portion 46. High temperature gutta percha is molded around the wire 18 to form the carrier 12. A portion of the wire 18 will extend out of the second end 28 of the carrier 12. The sheath 14 is molded over the carrier 12 and the portion of the wire 18 extending from the carrier 12 using low temperature gutta percha (i.e., gutta percha with a lower melting temperature than the gutta percha used to mold the carrier 12).

One of ordinary skill will recognize that other methods of making the endodontic obturator 10 are possible. For example, in an embodiment, the wire 18 may be inserted into the carrier 12 and the sheath 14. In another embodiment, the carrier 12 may be glued into the sheath 14. In a further embodiment, the sheath 14 is molded separately from the carrier 12, and the carrier 12 and sheath 14 are coupled using an interference fit. To create an interference fit, the carrier 12 is slightly larger than the cavity 40 of the sheath 14. For example, in an embodiment where the carrier 12 includes the tapered body 24 having a 4% taper and the second end 28 having a 0.25 mm tip, the sheath 14 may include the tapered body 32 having a 4% taper and the tip 44 of the cavity 40 being a 0.20 mm tip. The carrier 12 may be inserted through a silicone stopper (not shown) to facilitate the process of coupling the carrier 12 and the sheath 14. The stopper may be positioned about 16 mm to 18 mm up the carrier 12 from the second end 28. The carrier 12 is then carefully inserted into the cavity 40 of the sheath 14. The carrier 12 may be pushed as far as possible within the cavity 40 without breaking the carrier 12 or the sheath 14 to create an interference fit.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. An endodontic obturator for obturating a root canal comprising:
a wire made of a conductive material;
a carrier configured to releasably couple to the wire, the carrier being made of a first thermoset material; and
a sheath configured to slidably receive the carrier, the sheath being made of a second thermoset material;
wherein a melting temperature of the second thermoset material is lower than a melting temperature of the first thermoset material.

2. The endodontic obturator of claim 1, further comprising:
a handle configured to be coupled to the wire.

3. The endodontic obturator of claim 2, wherein the wire extends out of the handle and includes a metal contact portion.

4. The endodontic obturator of claim 2, wherein the handle includes a first handle portion releasably coupled to a second handle portion, the first handle portion being coupled to the wire and the second handle portion being adjacent to at least one of the carrier and the sheath.

5. A method of obturating a root canal using an endodontic obturator comprising a wire, a carrier, and a sheath, the method comprising:
positioning the endodontic obturator in the root canal;
ensuring the endodontic obturator is in a proper position by locating an apex of the root canal using the wire;
sealing an apex of the root canal with the sheath; and
removing the wire from the endodontic obturator.

6. The method of claim 5, wherein the endodontic obturator further comprises a handle including a first handle portion and a second handle portion and removing the wire includes pulling the first handle portion away from the second handle portion, the method further comprising:
securing the endodontic obturator in the proper position with the second handle portion when removing the wire.

7. A method of making an endodontic obturator comprising:
molding a carrier made of a first thermoset material around a conductive wire;
molding a sheath made of a second thermoset material; and
coupling the carrier and the sheath.

8. The method of claim 7, wherein molding the sheath made of the second thermoset material includes the second thermoset material having a melting temperature lower than a melting temperature of the first thermoset material.

9. The method of claim 7, wherein coupling the carrier and the sheath includes creating an interference fit between the carrier and the sheath.
